(19) United States
(12) Patent Application Publication
(10) Pub. No.: US 2023/0077170 A1
(43) Pub. Date: Mar. 9, 2023

(54) LOW VOLTAGE POWER GENERATION SYSTEM FOR FLUID PUMPING IN WELL OPERATIONS

(71) Applicant: Freemyer Industrial Pressure, L.P., Fort Worth, TX (US)

(72) Inventors: Len Freemyer, Fort Worth, TX (US); Greg Leos, North Richland Hills, TX (US); Siva Kunchala, Fort Worth, TX (US); Heston Starkey, Fort Worth, TX (US)

(21) Appl. No.: 17/941,492

(22) Filed: Sep. 9, 2022

Related U.S. Application Data
(60) Provisional application No. 63/242,344, filed on Sep. 9, 2021.

(51) Int. Cl. E21B 41/00; E21B 43/25

(52) U.S. Cl. CPC E21B 41/0085; E21B 43/25

(57) ABSTRACT

A transportable, low voltage power generation system for fluid pumping in well operations to stimulate a well or clean piping wherever it may be located. The system comprises an all-in-one unit power generation system designed to reduce the physical footprint on location and eliminate separate power generation equipment for geothermal, industrial cleaning, oil and gas horizontal and vertical stimulation operations that involve stimulating with abrasive laden fluids, homogenous fluids comprised of various chemicals in dry or liquid state, and water.

### CROSS-REFERENCE TO RELATED APPLICATIONS

This application claims the benefit of priority of U.S. Provisional Application No. 63/242,344, filed Sep. 9, 2021, which is hereby incorporated by reference in its entirety.

### FIELD

The present disclosure generally relates to a power generation system used to stimulate a well or clean piping wherever it may be located. More specifically, the present disclosure provides a transportable, all-in-one unit power generation system designed to reduce the physical footprint on location and eliminate separate power generation equipment for geothermal, industrial cleaning, oil and gas horizontal and vertical stimulation operations that involve stimulating with abrasive laden fluids, homogenous fluids comprised of various chemicals in dry or liquid state, and water.

### BACKGROUND

A generator set or “genset” is a transportable or stationary unit, comprising an engine and a generator that is used to provide energy. Gensets are often used in the oil and gas industry to generate power for hydraulic fracturing, well stimulation, and cementing equipment. They can also serve as a main or supplementary power source in other locations not connected to the power grid; places where power outages are frequent; and/or where a power outage can cause especially significant or dangerous problems, such as at oil well sites.

A genset generally consists of a prime mover, typically an engine or turbine, that converts the chemical energy of a fuel to mechanical energy and an electrical generator, typically comprising an alternator, that generates electricity. The mechanical energy from the engine spins the alternator, which creates a voltage on the alternator and the generator produces power. Conventional systems used today to operate gensets include diesel and or turbine powered generators fueled by natural gas, dual fuel, and other fuels.

The conventional gensets used in geothermal, industrial cleaning, and oil and gas horizontal and vertical stimulation operations, which are extremely large and can cost millions of dollars, generate high voltage to power the electrical equipment at the work site. The high voltage used in such conventional gensets is typically in excess of 1,500 V. A well site may a plurality of gensets to power multiple pumps. These gensets require discrete components, such as a disconnect system, remote switching gear, and step-down transformers, in order to deliver power to the equipment, such as pumps and blenders, which operate on lower voltages, and multiple high voltage cables are run on top of the ground to connect to each of the discrete components and equipment to deliver the necessary power.

Some systems have tried to eliminate reliance on high voltage turbine engines by using a reciprocator engine to power a genset. However, these gensets still require discrete machinery to power equipment, in addition to connecting the machinery with the requisite high voltage cables on top of the ground.

In addition to the space taken up by these elements of the gensets, the prior art systems have also required extensive, expensive, and potentially dangerous high voltage cabling between the discrete elements.

### SUMMARY

Applicant recognized the problems noted above herein and conceived and developed embodiments of systems and methods, according to the present disclosure, for all-in-one unit power generation systems for fluid pumping in well operations. The present system not only addresses these issues, but improves safety, saves costs, and provides more space to worksites over prior systems.

In one embodiment, a low voltage power generation system comprises a power engine generator and pumping equipment all provided on a single transportable support base. The components are combined so as to reduce the size of the system and to greatly reduce the usage of high voltage cables, clutter, and trip hazards at a worksite.

In one embodiment, the system uses a low voltage reciprocating engine generator, whereas conventional systems utilize separated high voltage turbine engine generators that require the use of discrete machinery to regulate and distribute the high voltages, including a disconnect system, remote switching gear, and step-down transformers. For example, the site layout of the conventional system shown in FIG. 3 includes eleven components that are connected by cables across the site.

Reducing the required space for multiple separate units of equipment in the work area and eliminating cabling running between those units will result in a less congested worksite.

By reducing the required voltage and components, the present system also improves the prior art by reducing manufacturing and operating costs.

In order to address the cooling issues for reciprocator engines in gensets, embodiments of the present system may include a radiator for the reciprocating engine, which allows the elements to be contained on one transportable support base with a smaller physical footprint.

### BRIEF DESCRIPTION OF THE DRAWINGS

For a more complete understanding of the present disclosure, reference is now made to the following description, taken in connection with the accompanying drawings and detailed description, wherein like reference numerals represent like parts.

FIG. 1 illustrates a schematic form of an embodiment of a low voltage power generation system on a single transportable support base;

FIG. 2 illustrates a schematic form of an embodiment the pumping unit of the low voltage power generation system according to FIG. 1;

FIG. 3 is a schematic of a conventional site layout; and

FIG. 4 depicts another conventional site layout.

### DETAILED DESCRIPTION

Embodiments of the present system are further described in detail below with reference to the accompanying drawings and embodiments. The following examples are intended to illustrate the present system, but are not intended to limit the scope of the invention.

The present disclosure describes a low voltage power generation system provided within a single transportable support base, such as on a trailer, skid, or other transportation device suitable to support the equipment. The system may also be installed at a worksite as a stationary unit.

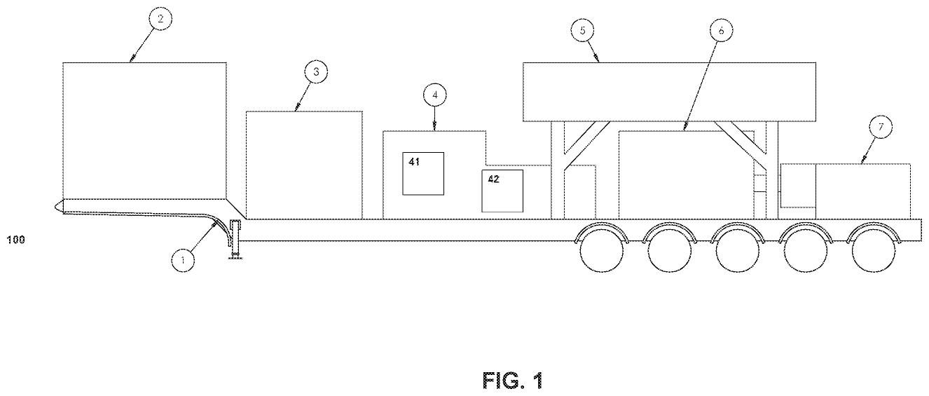

FIG. 1 depicts an embodiment of the lower voltage power system 100 comprising one or more variable frequency drives (VFD) 2, an engine generator 4, an electric motor 6, and a pumping unit 7, which are disposed on a single transportable support base 1. The engine generator 4 comprises a reciprocating engine and an alternator to generate power. Electricity from the engine generator 4 goes to the VFD 2. The VFD 2 sends power to and controls the speed of the electric motor 6. The electric motor 6 powers the pumping unit 7.

In one embodiment, the engine generator 4 includes a reciprocating engine 41 and an alternator 42. The reciprocating engine 41 it utilized as opposed to a turbine generator or diesel generator, which generally require more space and use high voltage The engine generator 4 provides a low voltage of less than 1,500 V. The reciprocating engine may be capable of utilizing onboard and offboard power, or combination thereof. The onboard power to the reciprocating engine may be supplied by a fuel, including natural gas, pipeline gas, compressed natural gas, field gas, flared gas, hydrogen, diesel fuel, or combination of fuels. When run on natural gas or a combination of other fuels, the engine may have a lower carbon footprint than other known fuels. Offboard power may be supplied by connection to the power grid or to a third-party source utilizing the power grid, and which may require external ground transformation and distribution at various voltages.

The engine generator 4 provides power to the VFD 2, which comprises electric converters and a rectifier. While a single VFD and electric motors are depicted in the illustrated embodiment, other embodiments of the present system may have a plurality of VFDs and electric motors to power the pump and the various other components. The one or more VFDs 2 may be located within an electrical enclosure on the unit. The engine generator 4 supplies the necessary electric power generation to the VFDs 2 to supply the converters, and the converters feed the rectifier to perform the proper power conversion for variable voltage frequency to vary the speed of the electric motor that is connected to the pump. The converters may be liquid-cooled or air-cooled electric converters, and a cooling system for the converters may comprise a heat exchanger for the liquid-cooled converters and a wall mounted HVAC system for the air-cooled converters.

The system may further include an energy storage system 3 disposed on the single transportable support base 1 which reduces the risk of the pump losing power. The energy storage system may be a battery energy storage system. If the engine runs out of fuel or otherwise loses power, the energy storage system can automatically provide power and allows continued pump operation. On a well site, a loss of power to a pump may cause formation performance issues and dangerous soil contamination.

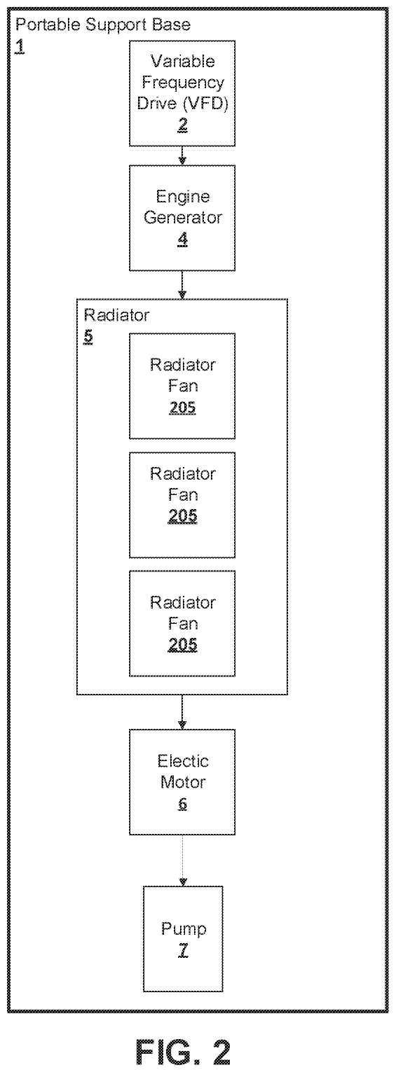

The system may further include a radiator 5 to cool the reciprocating engine generator 4. The radiator 5 may be elevated and oriented horizontally above a platform of the transportable support base 1 such that it is located above one or more of the other components of the system. The radiator 5 may further include multiple sections and fans. FIG. 2 depicts an embodiment including three sections of the radiator 5 with three individual radiator fans 205. As shown in the embodiment in FIG. 2, the radiator 5 is only connected to the reciprocating engine generator 4 by cooling pipes and is located above the electric motor 6 and the alternator, but the radiator 5 may be located in other locations in other embodiments. The separation between the radiator 5 and the reciprocating engine generator 4 reduces hot exhaust entering the radiator 5. This also provides a smaller footprint and more room for the remainder of the components to be disposed on a single transportable support base 1.

The pumping unit 7 pumps fluid into a wellbore or piping for geothermal, industrial cleaning, oil and gas horizontal and vertical stimulation operations. The pumping unit 7 may comprise a reciprocating positive displacement pump. The system may include a single pumping unit such that the engine generator 4 is a dedicated power generation source for the single pumping unit, as depicted in the embodiment in FIG. 1, but other embodiments may be configured to include a plurality of pumping units powered by the engine generator 4.

The system may include a control system that controls operation of the generator set. The control system may provide a first mode for limiting torque applied during pressure testing, and a second mode for ramping up to increase speed for pump assemblies providing additional protection to the pump's input torque and reducing premature pump failures.

The system may utilize a lower dual voltage compared to high voltage currently used in the market space. This method eliminates the need for additional equipment required for transforming high voltage to low voltage, such as separate switch gear, and high voltage cables connecting the power generators to the switch gear and then to an electrical enclosure that stows the one or more VFDs 2 powering the pump 7.

All the equipment for powering a pump at the well site can fit in one transportable support base 1 due the elimination of the high-to-low voltage transformer and remote switch gear, and the horizontally mounted radiator 5 that is elevated above the other components, thus reducing the physical footprint and the need for high voltage cables across the ground going from the generator to the motors.

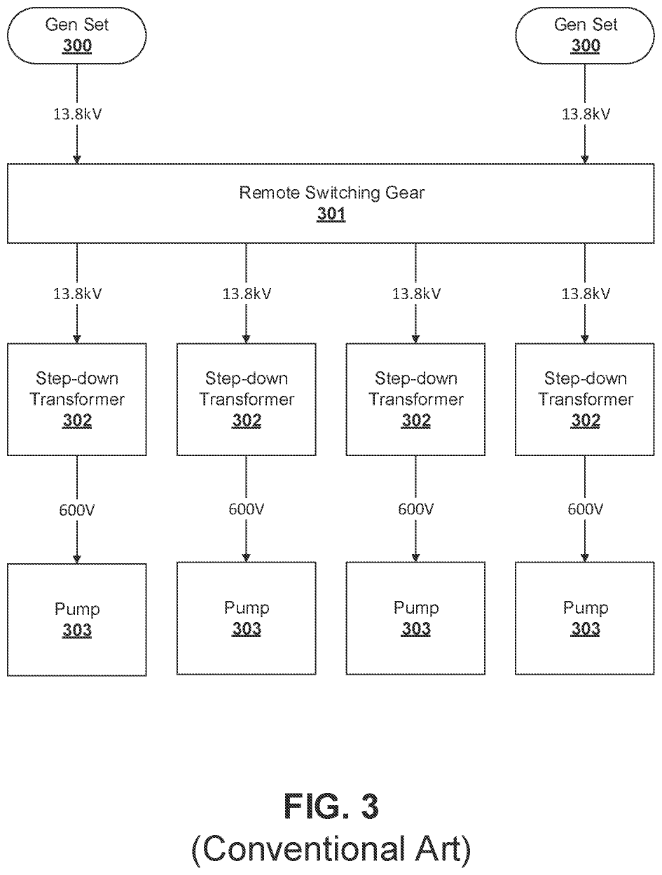

FIG. 3 illustrates the site layout of a conventional system using high voltage turbine engine generators. In order to power four pumps, the system of FIG. 3 uses two gensets, 300, which are connected by two 13,800 V high-voltage power lines to remote switching gear 301. The remote switching gear 301 is connected by four 13,800 V high-voltage power lines to four discrete step-down transformers 302. The four discrete step-down transformers 302 are connected by four 600 V power lines to four discrete pumps 303. While FIG. 3 includes eleven discrete components connected by cables across the worksite to power four pumps, the embodiment of the present system shown in FIG. 2 may power one or more pumps without using discrete high-voltage machinery. This makes the embodiments of the present system safer at the job site due to their smaller size, which allows all the equipment to fit on a single support base. Moreover, cable management for the present system will be installed on the transportable support base 1 and not externally on the ground, which increases safety, reduces worksite clutter, and saves operational and manufacturing costs.

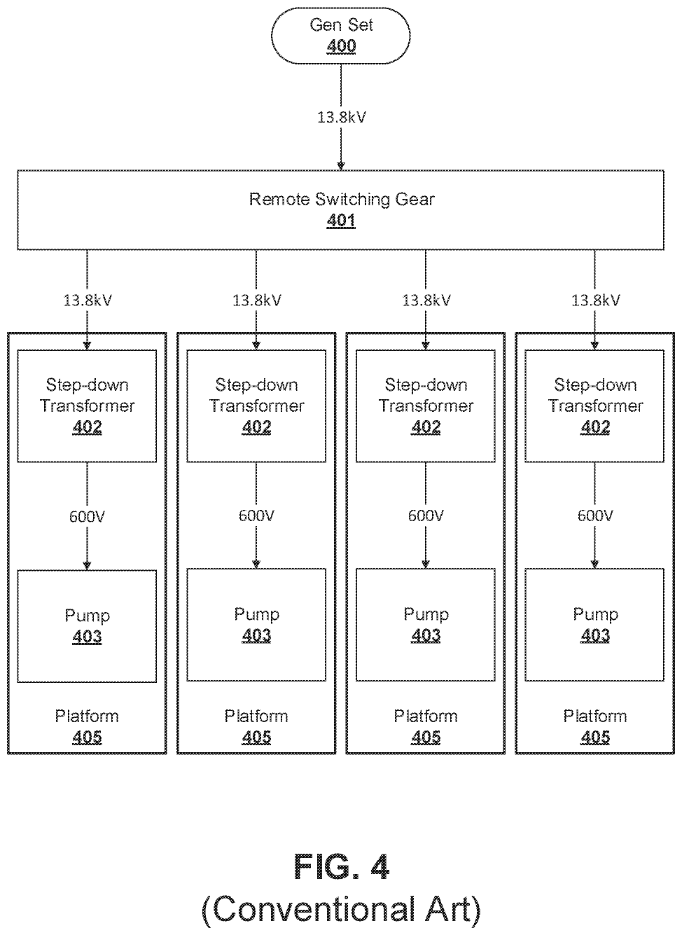

FIG. 4 illustrates another site layout of a conventional system. In this system, a single large turbine genset 400 connects 13,800 V high-voltage power lines to remote switching gear 401. The remote switching gear 401 is connected by four 13,800 V high-voltage power lines to four discrete step-down transformers 402. The four step-down transformers, 402, are connected by four 600 V power lines to four pumps 403. The step-down transformers and the pumps are affixed in pairs to four platforms 405. While FIG. 4 includes less discrete components than the conventional system in FIG. 3, the embodiment of the present invention shown in FIG. 2 may power one or more pumps without using discrete high-voltage machinery such as remote switching gear 401. This makes the FIG. 2 embodiment safer at the job site due to its low voltage operation which increases safety, reduces worksite clutter, and saves operational and manufacturing costs.

The above description is only to example embodiments of the present system and it should be noted that those skilled in the art can make improvements and modifications without departing from the technical principles of the present system and as such, variations are also considered to be within the scope of protection of the present disclosure herein and the scope of the appended claims.

What is claimed is:

1. A low voltage, power generation system comprising:
a pumping unit to pump fluid to a well bore or pipe;
a low voltage reciprocating engine generator;
an electric motor which drives the pumping unit;
a radiator for cooling the reciprocating engine generator;
a variable frequency drive connected to receive power from the generator, wherein the variable frequency drive sends power to and controls the speed of the electric motor and sends power to the radiator to cool the engine generator; and
a single transportable support base, wherein each of the pumping unit, engine generator, electric motor, radiator, and variable frequency drive are disposed on the support base.

2. The system of claim 1, wherein the transportable support base comprises one of a trailer or a skid which is sized to support and transport the power generation system.

3. The system of claim 1, wherein the reciprocating engine generator is fueled by one or more of natural gas, pipeline gas, compressed natural gas, field gas, flared gas, hydrogen, and diesel fuel.

4. The system of claim 1, wherein the system includes a single pumping unit, and the generator is a dedicated power generation source for the single pumping unit.

5. The system of claim 1, wherein the one or more variable frequency drives are contained within an electrical enclosure disposed on the transportable support base.

6. The system of claim 1, wherein the radiator is elevated above a platform of the transportable support base and oriented horizontally such that it is located above one or more of the reciprocating engine generator, the electric motor, the variable frequency drive, and the pumping unit.

7. The system of claim 1, wherein the radiator further comprises two or more sections that are cooled by two or more radiator fans.

8. The system of claim 1, wherein the system includes a control system comprising:
a first mode for limiting torque applied during pressure testing; and
a second mode for ramping up to increase speed for pump assemblies.

9. The system of claim 1, wherein the system further comprises an energy storage system that automatically provides power to the system if the engine generator fails to supply power.
